(19) United States
(12) Patent Application Publication
(10) Pub. No.: US 2026/0188818 A1
(43) Pub. Date: Jul. 2, 2026

(54) CABLE SKID RAPID DEPLOYMENT SYSTEM FOR MODULAR BATTERY ENERGY STORAGE SYSTEMS (BESS)

(71) Applicant: Fluence Energy, LLC, Arlington, VA (US)

(72) Inventors: Steven McCaffrey, Torquay (AU); Suhas S, Bangalore (IN)

(73) Assignee: Fluence Energy, LLC, Arlington, VA (US)

(21) Appl. No.: 19/437,066

(22) Filed: Dec. 30, 2025

Related U.S. Application Data
(60) Provisional application No. 63/739,703, filed on Dec. 30, 2024.

(51) Int. Cl. H01M 50/251; H01M 50/204; H01M 50/258; H01M 50/298

(52) U.S. Cl. CPC H01M 50/251; H01M 50/204; H01M 50/258; H01M 50/298; H01M 2220/10

(57) ABSTRACT

A modular battery energy storage system (BESS) includes a cable skid system and a BESS node configured for attachment to the cable skid system. The cable skid system includes cable skid system cabling, a BESS mounting frame, and an electrical connection. The BESS node includes BESS node cabling that is configured for connection to the cable skid cabling of the cable skid system. The electrical connection is configured for connecting the BESS node cabling with the cable skid cabling. The cable skid system further includes a plurality of locating feature protrusions, and a plurality of locating feature receptacles. Each of the plurality of locating feature protrusions is arranged at a corner portion of the cable skid system, and each of the locating feature receptacles is arranged at a respective corner portion of the cable skid system.

### CROSS-REFERENCE TO RELATED APPLICATIONS

This application claims the benefit of U.S. Provisional Application No. 63/739,703, filed on Dec. 30, 2024, which is hereby incorporated by reference in its entirety.

### INTRODUCTION

The concepts described herein relate generally to battery energy storage systems (BESSs), and more specifically, to a cable skid rapid deployment system for a BESS unit or BESS node of a BESS.

Current BESSs generally include a plurality of individual BESS units or nodes arranged within a BESS enclosure. Each BESS node includes a plurality of battery modules arranged in a battery rack or racks, and other BESS components, for example but not limited to chillers, heating, ventilation, and air conditioning (HVAC) systems, and/or power conversion systems (PCS), arranged within the BESS enclosure having a floor, a rear side, left and right sides, doors, and a roof.

The configuration of the battery rack or racks and other BESS components arranged within each BESS node varies to meet the needs of different markets, and energy matching requirements across each BESS product line. To keep up with the changing market needs, implementation of changes within each BESS node, and into and across each BESS product line requires significant change-over time, effort, and cost in implementation.

Each BESS node includes BESS node cabling configured to electrically connect the BESS node to, for example but not limited to, one another, a power control system (PCS), and/or a transformer via cable system cabling.

The BESS node cabling from each BESS node is connected to the cable system cabling that runs underground to electrically connect the BESS nodes to, for example but not limited to, one another, the PCS, and/or the transformer.

Prior to installation of each BESS node, an installation site needs to be prepared, which includes: excavation of the installation site to accommodate conduits, cables, and culverts; installation of the culverts, conduits, and hard cover; and installation of the cables electrically connecting the BESS nodes to one another, and the BESS nodes to the PCS and/or transformer.

To keep up with the changing market needs, implementation of changes within each BESS node, and into and across each BESS product line may require removal, updating, and installation of updated BESS nodes.

Installation of updated BESS nodes requires preparation and/or updating of the installation site, requiring significant installation time, effort, and cost.

As such, it would be advantageous to provide a cable skid rapid deployment system for modular BESSs that facilitates installation of updated BESS nodes, while minimizing installation site preparation time, labor, and materials.

### SUMMARY

In view of the above discussion, it is useful to provide a cable skid rapid deployment system for modular BESSs that facilitates re-installation/installation of updated and/or new individual BESS nodes, while minimizing installation site preparation time, effort, and cost.

The concepts disclosed herein relate to a cable skid rapid deployment system (cable skid system) for a modular BESS. The cable skid system may include a BESS mounting frame, cable skid system cabling, and an electrical connection system. The BESS mounting frame may include a cross beam. The cross beam may have an opening for the cable skid system cabling, and an electrical connection system access. The cable skid system cabling may include a first end that may be configured to be electrically connected to BESS node cabling within BESS node or nodes, and a second end that may be configured to be electrically connected to an electrical connection system.

The electrical connection system may include a first portion and a second portion. The first portion may have a first plurality of electrical connections, and the second portion may have a second plurality of electrical connections. The first plurality of electrical connections may be located within the BESS mounting frame and may be configured for electrical connection to the BESS node cabling of a BESS node. The second plurality of electrical connections may be located within the BESS mounting frame and may be configured for electrical connection to an external unit, for example but not limited to, another BESS enclosure, the PCS, and/or the transformer via the electrical connection system access.

A covered cabling system may be included in the BESS mounting frame. The covered cabling system may include a top portion. The cable system cabling, conduits, and the like may be included within the covered cabling system within the BESS mounting frame of the cable skid system.

According to one aspect of the disclosure, a cable skid system may include a top portion adjacent to a top surface of the BESS mounting frame, and a plurality of cable skid system locating features.

Each cable skid system locating feature may include a locating feature protrusion, and a locating feature receptacle, which may be adjacent to the locating feature protrusion. Each locating feature protrusion of each cable skid system locating feature may extend from a top portion of the cable skid system. Each locating feature receptacle may extend from a bottom portion of the cable skid system.

A plurality of cable skid systems may be stacked in a stacked configuration. A second cable skid system of the plurality of cable skid systems may be stacked on a first cable skid system of the cable skid systems, such that the first cable skid system locating feature protrusions may be received within the second cable skid system locating feature receptacles. This stacked configuration may facilitate storage and retrieval of the plurality of cable skid systems for faster commissioning and deployment.

A modular battery energy storage system (BESS) is also disclosed. The modular BESS may include a cable skid system including cable system cabling, as described above, and a BESS node configured for attachment to the cable skid system. The BESS node may include BESS node cabling which may be configured for connection to the cable system cabling of the cable skid system.

By providing a cable skid rapid deployment system for modular BESSs that facilitates installation of updated BESS nodes and/or new BESS enclosures, installation site preparation time, effort, and cost may be minimized.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

The accompanying drawings, which are incorporated into and constitute a part of this specification, illustrate implementations of the disclosure which, taken together with the description, serve to explain the principles of the disclosure.

FIG. 1 is a front-view illustration of a representative battery energy storage system (BESS) in accordance with which aspects of the present disclosure may be practiced.

FIG. 1A is a schematic isometric view of another battery energy storage system (BESS) in accordance with which aspects of the present disclosure may be practiced.

FIG. 2 schematically illustrates an embodiment of a power plant including a battery energy storage system (BESS) node and a cable skid system, in operative communication with and operably connected to an energy system, e.g., an electric grid, in accordance with which aspects of the present disclosure may be practiced.

FIG. 3 schematically illustrates a side view of a BESS node in operative communication and operably connected to a cable skid system, in accordance with which aspects of the present disclosure may be practiced.

FIG. 4 schematically illustrates an isometric view of a BESS node and cable skid system, in accordance with which aspects of the present disclosure may be practiced.

FIG. 4A schematically illustrates an isometric view of an electrical connection system, in accordance with aspects of the present disclosure.

FIG. 4B schematically illustrates an isometric end view of a covered cabling system, in accordance with which aspects of the present disclosure may be practiced.

FIG. 5 schematically illustrates an isometric top view of a cable skid system, in accordance with which aspects of the present disclosure may be practiced.

FIG. 5A schematically illustrates an isometric view of a plurality of cable skid systems, in accordance with which aspects of the present disclosure may be practiced, in a stacked configuration.

FIG. 5B schematically illustrates an exploded isometric top view of a corner section of a cable skid system, in accordance with which aspects of the present disclosure may be practiced.

FIG. 6 is a partially schematic perspective-view illustration of a representative energy storage system in accordance with which aspects of the present disclosure may be practiced.

FIG. 7 is a partially schematic front-view illustrations of the representative energy storage system of FIG. 6.

The appended drawings are not necessarily to scale and may present a somewhat simplified representation of various preferred features of the present disclosure as disclosed herein, including, for example, specific dimensions, orientations, locations, and shapes. Details adjacent to such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments may be practiced without some of these details. Moreover, for the purpose of clarity, certain technical material that is understood in the related art has not been described in detail in order to avoid unnecessarily obscuring the disclosure. Furthermore, the disclosure, as illustrated and described herein, may be practiced in the absence of an element that is not specifically disclosed herein.

The present disclosure is susceptible of embodiment in many different forms. Representative examples of the disclosure are shown in the drawings and described herein in detail as non-limiting examples of the disclosed principles. To that end, elements and limitations described herein, but not explicitly set forth in the claims, are not to be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including,” “containing,” “comprising,” “having,” and the like shall mean “including without limitation.” Moreover, words of approximation such as “about,” “almost,” “substantially,” “generally,” “approximately,” etc., may be used herein in the sense of “at, near, or nearly at,” or “within 0-5% of,” or “within acceptable manufacturing tolerances,” or logical combinations thereof.

As used herein, the term “system” refers to mechanical and electrical hardware, software, firmware, electronic control componentry, processing logic, and/or processor device, individually or in combination, including without limitation: application specific integrated circuit (ASIC), an electronic circuit, a processor (shared, dedicated, or group) that executes one or more software or firmware programs, memory device(s) that electrically store software or firmware instructions, a combinatorial logic circuit, and/or other components that provide the described functionality.

As employed herein, terms such as “vertical”, “horizontal”, “left”, “right”, “upper”, “lower”, “top”, “bottom” and similar expressions are non-limiting terms that merely describe the various elements as illustrated in the Figures and are not intended to limit the scope of the disclosure.

The use of ordinals such as first, second, and third does not necessarily imply a ranked sense of order, but rather may only distinguish between multiple instances of an act or structure.

All numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; about or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of all values and further divided ranges within the entire range. Each value within a range and the endpoints of a range are hereby all disclosed as separate embodiments.

The term “controller” and related terms such as microcontroller, control, control unit, processor, etc. refer to one or various combinations of Application Specific Integrated Circuit(s) (ASIC), Field-Programmable Gate Array(s) (FPGA), electronic circuit(s), central processing unit(s), e.g., microprocessor(s) and associated non-transitory memory component(s) in the form of memory and storage devices (read only, programmable read only, random access, hard drive, etc.). The non-transitory memory component can store machine readable instructions in the form of one or more software or firmware programs or routines, combinational logic circuit(s), input/output circuit(s) and devices, signal conditioning, buffer circuitry and other components, which may be accessed by and executed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms, and similar terms mean controller-executable instruction sets including calibrations and look-up tables. Each controller executes control routine(s) to provide desired functions. Routines may be executed at regular intervals, for example every 100 microseconds during ongoing operation. Alternatively, routines may be executed in response to occurrence of a triggering event. Communication between controllers, actuators and/or sensors may be accomplished using a direct wired point-to-point link, a networked communication link, a wireless link, or another communication link. Communication includes exchanging data signals, including, for example, electrical signals via a conductive medium; electromagnetic signals via air; optical signals via optical waveguides; etc. The data signals may include discrete, analog and/or digitized analog signals representing inputs from sensors, actuator commands, and communication between controllers.

The term “signal” refers to a physically discernible indicator that conveys information, and may be a suitable waveform (e.g., electrical, optical, magnetic, mechanical, or electromagnetic), such as DC, AC, sinusoidal-wave, triangular-wave, square-wave, vibration, and the like, that is capable of traveling through a medium.

The terms “calibration”, “calibrated”, and related terms refer to a result or a process that correlates a desired parameter and one or multiple perceived or observed parameters for a device or a system. A calibration as described herein may be reduced to a storable parametric table, a plurality of executable equations or another suitable form that may be employed as part of a measurement or control routine.

A parameter is defined as a measurable quantity that represents a physical property of a device or other element that is discernible using one or more sensors and/or a physical model. A parameter may have a discrete value, e.g., either “1” or “0”, or may be infinitely variable in value.

An energy system may include, for example, any system arranged to generate, transmit, convert, distribute, store, and/or use energy (e.g., electrical energy) and/or associated with any other aspect of energy. As one example, an energy system may include an electric grid. An electric grid may include, for example, an interconnected network for electricity delivery from producers to consumers. An electric grid may include, for example, power stations (e.g., thermal power stations, photovoltaic power stations, solar farms, wind power stations, wind farms, hydroelectric power stations, etc.), substations (e.g., for transforming voltage from higher to lower voltage levels, or from lower to higher voltage levels, or for performing other functions associated with transmitting electrical energy between producers and consumers), electrical power transmission and/or distribution (e.g., transmitting electrical energy from producers to substations, and/or delivering electrical energy from a transmission system to consumers), and/or other elements.

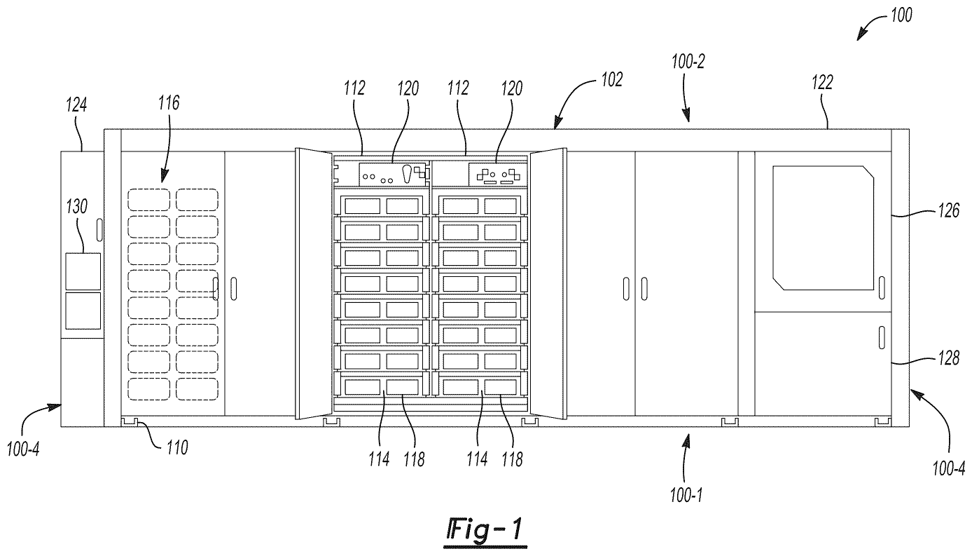

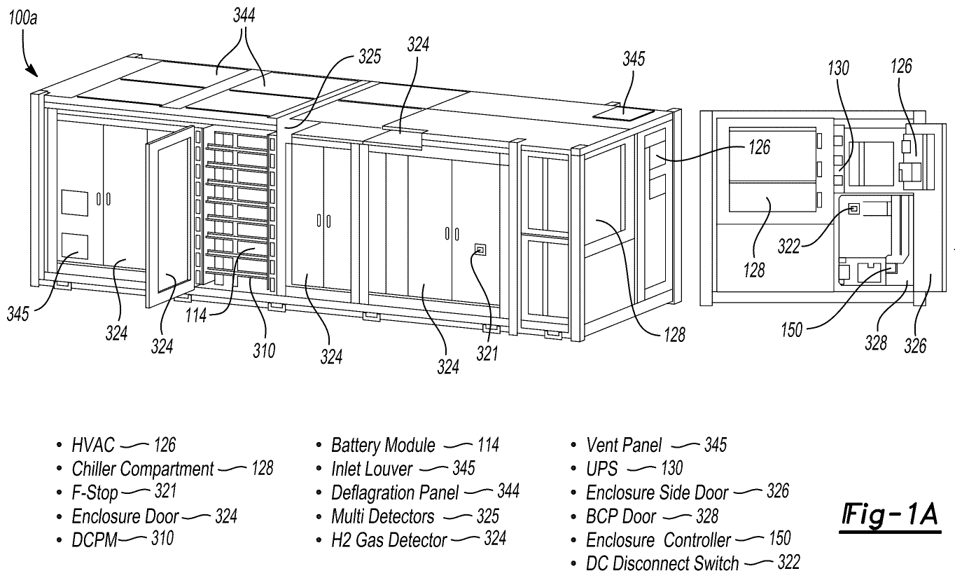

Referring to the drawings, wherein like reference numbers refer to the same or like components in the several Figures, FIG. 1 schematically illustrates a power plant 100 including a representative battery system, which is designated generally at 102 and portrayed therein for purposes of discussion as an interconnected network of high energy modular BESS node 104 having a plurality of nodes or BESS enclosures 120, an external unit 130, which may include for example but not limited to a power conversion system and/or a transformer, and a thermal management system 140.

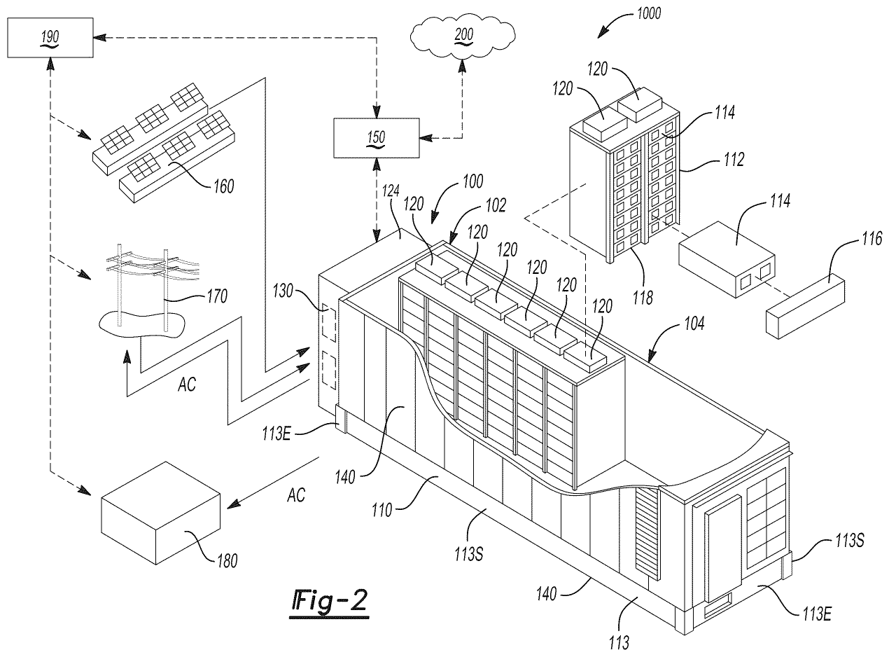

Referring to the drawings, wherein like reference numbers refer to the same or like components in the several Figures, FIG. 1 schematically illustrates a representative battery system, which is designated generally at 100 and portrayed therein for purposes of discussion as an interconnected network of high energy density, large discharge capacity modular battery energy storage system (BESS) nodes. The illustrated battery system 100 - also referred to herein as “nodal BESS network” or “BESS” for short - is merely an exemplary application with which novel aspects of this disclosure may be practiced. In the same vein, incorporation of the present concepts into the nodal BESS network of FIG. 2 for storing and dispensing energy in a utility power grid with two renewable energy subsystems should also be appreciated as non-limiting applications of disclosed features. As such, it will be understood that aspects and features of this disclosure may be utilized for a variety of different BESS form factors, integrated into assorted BESS network architectures, and incorporated into any logically relevant type of energy storage system. Moreover, only select components of the BESS node and BESS network are shown and described in detail below. Nevertheless, the BESS nodes and networks discussed herein may include numerous additional and alternative features, and other available peripheral hardware, for carrying out the various methods and functions of this disclosure.

The battery system 100 of FIG. 1 contains one or more modular BESS nodes 102, for example, to provide energy storage for load levelling of an electrical grid or energy storage for transient sources of electrical energy, such as solar cells or wind turbine generators. Each BESS node 102 may include a protective, weather-resistant BESS enclosure 110 within which are stored the energy storage devices and attendant componentry of the BESS 100. As shown, the BESS enclosure 110 houses a row of (six) battery racks 112 that each supports thereon a set of (eight) battery modules 114. Each battery module 114 contains a stack of (sixteen) rechargeable battery cells 116, such as lithium-ion, sodium-ion, or vanadium flow cells, and a bottom-layer battery module unit (BMU) 118 that functions as a supervisory component for monitoring and coordinating operation of the battery cells 116. Moduleaged on top of each rack 112 is a middle-layer battery cluster management (BCM) unit 120 that sits at the middle tier of the BESS's hierarchical Battery Management System (BMS) for receiving and processing data from the multiple BMUs 118 within its designated battery cluster.

Located at opposing ends of the BESS enclosure 110, adjacent the storage cabinets that stow the battery racks 112, are two self-contained hardware bays 122 and 124 for housing auxiliary components that support the efficient functioning of the BESS node 102. For instance, bay 122 of FIG. 1 may house a heating, ventilating, air conditioning (HVAC) system 126 that governs the internal operating temperatures inside the cabinets where the battery modules 114 are located. Hardware bay 122 may also house a chiller 128 for selectively chilling coolant that is circulated to the battery modules 114 in order to maintain the battery cells 116 within their specified operational temperature ranges. Located within bay 122, at the opposite end of the BESS enclosure 110, is one or more external units 130, which may include, for example but are not limited to, a bidirectional power transformer that boosts (“steps-up”) voltage output by the battery cells 116 to a level suitable for the grid or other components within the system, or decreases (“steps-down”) incoming voltage for recharging the battery cells 116, and/or a power conversion system that is configured to standardize power input and output between the plurality of BESS nodes 102 and the external power source 160. The power conversion system may include, for example but not limited to, one or multiple power converters (or inverters) configured to convert AC power to DC power, and/or DC power to AC power.

Referring to FIG. 1A, a schematic isometric view of yet another energy storage system 100a is shown in accordance with one or more exemplary embodiments. The energy storage system 100a generally includes a BESS node 102, a controller (BESS controller) 150, a DCPM 310, a HVAC 126, a direct current (DC) disconnect switch 322, a deflagration panels 124, a uninterruptable power system (UPS) 130, battery modules 114, a chiller compartment 152, a fast stop (F-stop) 321, an enclosure door 324, an inlet louver 345, multi detectors 325, a hydrogen (H₂) gas detector 327, a vent panel 345, an enclosure side door 326, and a battery cooling plate (BCP) door 328.

Referring to FIG. 2 with continued reference to FIGS. 1 and 1A, a power plant 1000 for a utility power grid includes a battery energy storage systems (BESS) 100 in communication with a BESS controller 150, which is configured to monitor and control the various components included in the BESS 100. The BESS 100 includes one or more BESS nodes 102. Each of the BESS nodes 102 includes a battery rack 112 having a plurality of battery modules 114. Each of the plurality of battery modules 114 includes a plurality of battery cells 116 arranged within each of the plurality of battery modules 114.

The one or more BESS nodes 102 are coupled to one another electrically, and collectively coupled to an external unit 130, which may include, for example but are not limited to, a bidirectional power transformer that boosts (“steps-up”) voltage output by the battery cells 116 to a level suitable for the grid or other components within the system, or decreases (“steps-down”) incoming voltage for recharging the battery cells 116, and/or a power conversion system that is configured to standardize power input and output between the plurality of BESS nodes 102 and the external power source 160. The power conversion system may include, for example but not limited to, one or multiple power converters (or inverters) configured to convert AC power to DC power, and/or DC power to AC power.

The BESS nodes 102, individually and collectively, are operable to store alternating current (AC) power delivered from an external power source 160 as direct current (DC) power, for example but not limited to when the demand for power from the external power source 160 is lower than the external power source 160 is operable to generate, and/or to provide DC power for an electrical application 170, which may include an electrical grid, for example but not limited to when the demand for power is higher than the external power source 160 is operable to generate. It should be appreciated that the one or more BESS nodes 102 may be coupled to one another not only electrically, but also mechanically, and/or fluidly.

According to one aspect of the disclosure, to facilitate the conversion of AC power to DC power and DC power to AC power, the external unit 130 includes a power conversion system that is configured to standardize power input and output between the plurality of BESS nodes 102 and the external power source 160. The power conversion system may include, for example but not limited to, one or multiple power converters (or inverters) configured to convert AC power to DC power, and/or DC power to AC power.

According to one aspect of the disclosure, the BESS 100 is configured to provide power to an auxiliary power system 180, which may include but is not limited to battery and power converter thermal management, control systems, communications, etc.

A substation controller 190 communicates with the BESS plant controller 150 to operate and monitor the power plant 1000 including but not limited to receiving commands from a customer and converting the commands into BESS controls and site-specific commands.

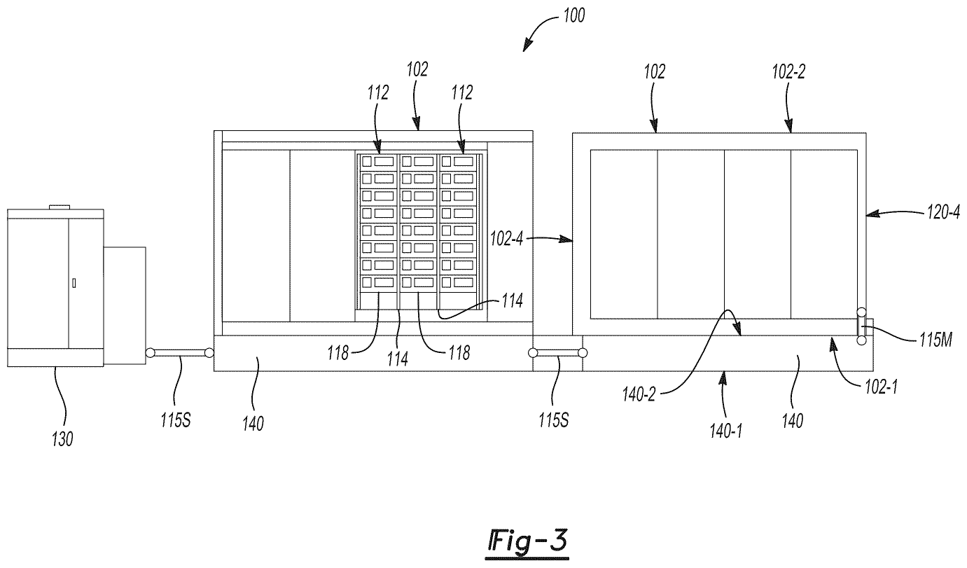

As schematically illustrated in FIG. 3, a battery energy storage system (BESS) 100 is arranged adjacent to a cable skid system 140. The BESS 100 includes one or more of BESS nodes 102, and an external unit 130, which may include, for example but are not limited to, a bidirectional power transformer that boosts (“steps-up”) voltage output by the battery cells 116 to a level suitable for the grid or other components within the system, or decreases (“steps-down”) incoming voltage for recharging the battery cells 116, and/or a power conversion system that is configured to standardize power input and output between the plurality of BESS nodes 102 and the external power source 160. The power conversion system may include, for example but not limited to, one or multiple power converters (or inverters) configured to convert AC power to DC power, and/or DC power to AC power.

The cable skid system 140 includes a bottom surface 140-1 and a top surface 140-2. Each BESS node 102 includes at least one battery rack 112 including a plurality of battery modules 114. Each BESS 100 is configured to be connected mechanically, fluidly, and/or electrically to the cable skid system 140.

The BESS 100 includes a bottom portion 100-1, a top or roof portion 100-2, two side portions 100-3, and two end portions 100-4. The bottom portion 100-1 of the BESS 100 is configured to be mechanically connected to the top surface 140-2 of the cable skid system 140.

Cabling 115N associated with each BESS node 102, i.e., BESS node cabling, is configured to be electrically connected to cabling 115S associated with the cable skid system 140, i.e., cable system cabling, which is configured to electrically connect BESS nodes 102 to, for example but not limited to, one another, the external unit 130, the HVAC 126, and/or the chiller 128.

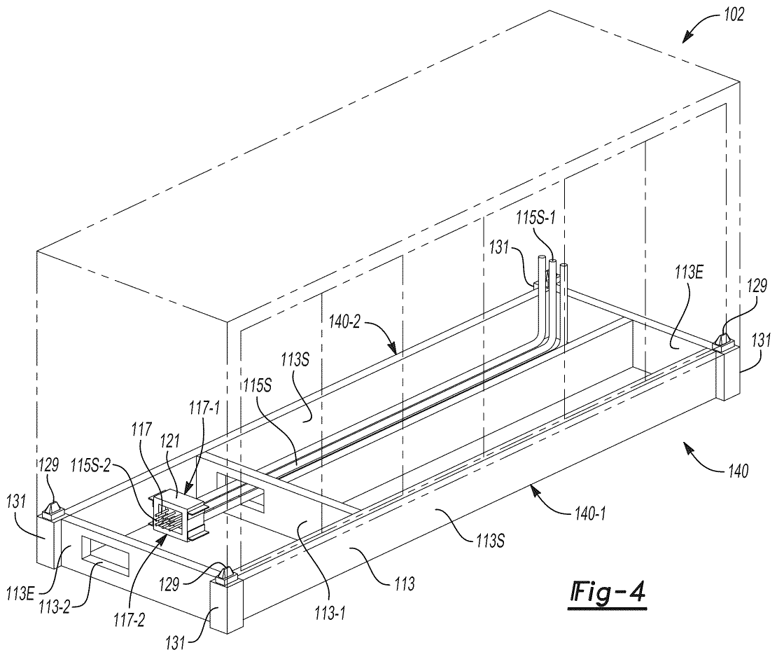

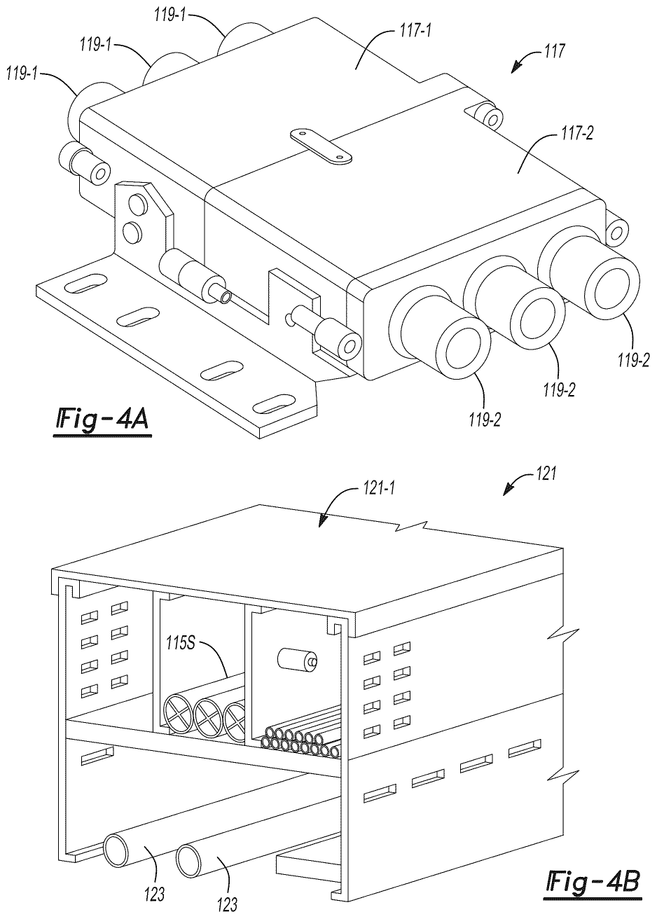

According to one embodiment of the disclosure, as schematically illustrated in FIG. 4, one or more BESS nodes 102 are connected mechanically and/or electrically to a cable skid system 140 having a bottom surface 140-1 and a top surface 140-2. Each BESS node 102 includes a bottom portion 102-1, a top or roof portion 102-2, two side portions 102-3, and two end portions 102-4. The bottom portion 102-1 of each BESS node 102 is configured to be mechanically connected to the top surface 140-2 of the cable skid system 14N.

As schematically illustrated in FIG. 4, a BESS 100 includes a BESS node 102 and a cable skid system 140. The BESS node 102 includes a bottom surface 102-1, a top surface 102-2, side surfaces 102-3, and end surfaces 102-4. The cable skid system 140 includes a bottom surface 140-1, and a top surface 140-2. The bottom surface of the BESS node 102 is arranged adjacent to the top surface 140-2 of the cable skid system 140.

The cable skid system 140 includes a BESS mounting frame 113, cable system cabling 115S, and an electrical connection system 117. The BESS mounting frame 113 includes a cross beam 113-1 having an opening 113-2 for the cable system cabling 115S, and electrical connection system 117 access. The cable system cabling 115S includes a first end 115S-1 that is configured to be electrically connected to BESS node cabling 115N associated with each BESS node 102, and a second end 115S-2 that is configured to be electrically connected to the electrical connection system 117. It should be appreciated that while a single cross beam 113-1 is illustrated as extending between opposing sides 113S of the BESS mounting frame 113, the BESS mounting frame 113 may include more than one cross beams 113-1, which may extend between opposing sides 113S of the BESS mounting frame 113 and/or between opposing ends 113E of the BESS mounting frame 113.

As schematically illustrated in FIG. 4A, an electrical connection system 117 includes a first portion 117-1 having a first plurality of electrical connections 119-1, and a second portion 117-2 having a second portion of electrical connections 119-2. The first plurality of electrical connections 117-1 is located within the BESS mounting frame 113 and configured for electrical connection to the BESS node cabling 115N of a BESS node 102 and/or BESS enclosure 110 within the same BESS node 102. The second plurality of electrical connections 117-2 is located within the BESS mounting frame 113 and configured for electrical connection to the external unit 130, which includes for example but not limited to a bidirectional power transformer, and/or a power conversion system as discussed above, via the opening 117-2 for electrical connection system 117 access.

As schematically illustrated in FIG. 4B, a covered cabling system 121 may be included in the BESS mounting frame 113. The covered cabling system 121 may include a top portion 121-1, or cover. The cable system cabling 115S, conduits 123, electrical connections 119-1, 119-2 and the like are included within the covered cabling system 121 within the BESS mounting frame 113 of the cable skid system 140.

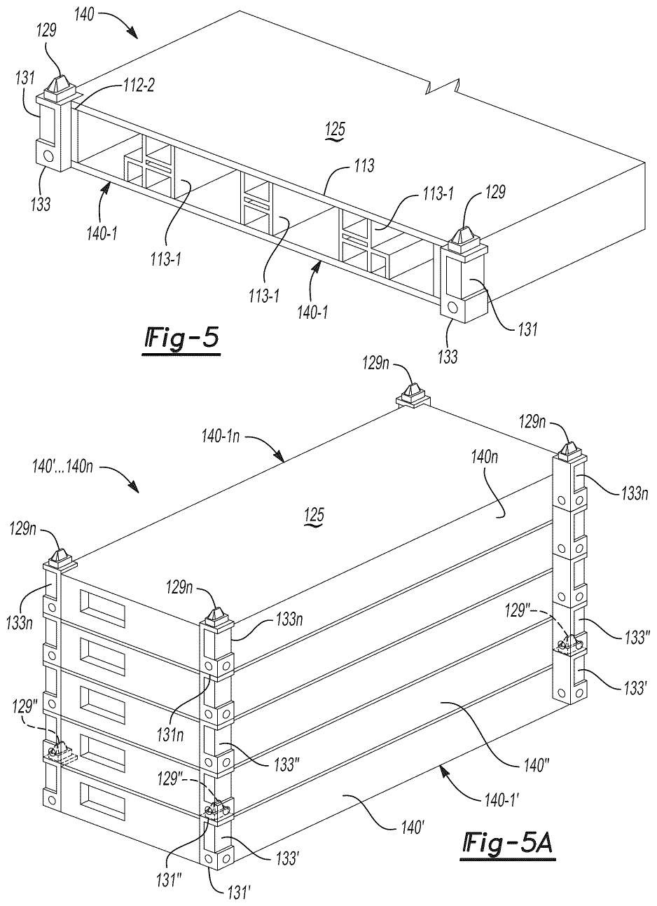

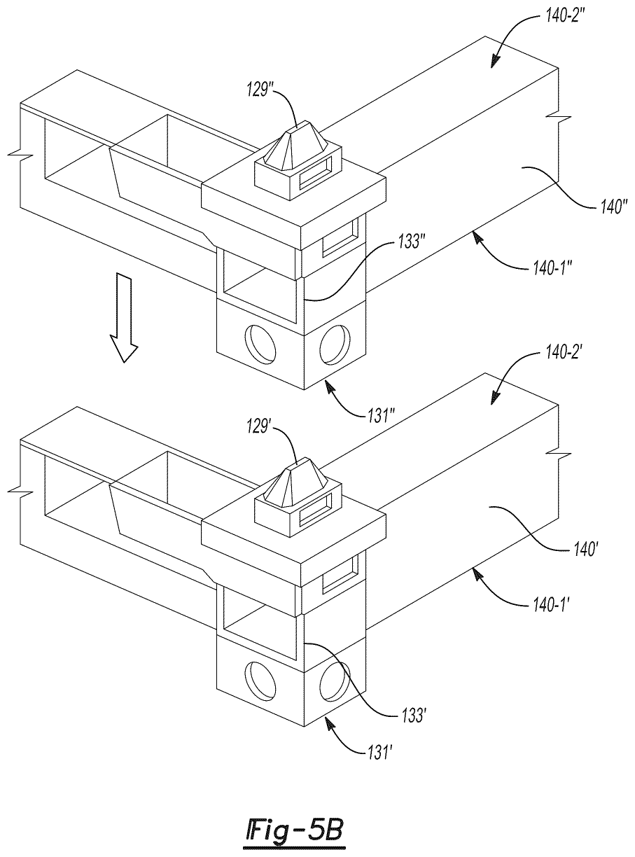

As illustrated in FIG. 5, a cable skid system 140 includes a top surface plate 125 adjacent to a top surface 140-2 of the cable skid system 140, and a plurality of cable skid system locating features 127 arranged, for example but not limited to, at corner portions 131 of the cable skid system 140.

As illustrated in FIG. 5A, a plurality of cable skid systems is shown in a stacked configuration. Each cable skid system 140′, 112″, . . . 140n includes respective locating feature protrusions 129′, 129″, . . . 129n arranged at respective corner portions 131′, 131″, . . . 131n and respective locating feature receptacles 133′, 133″, . . . 133n arranged at respective corner portions 131′, 131″, . . . 131n of each respective cable skid system 140′, 140″, . . . 140n. The cable skid systems 140′, 140″, . . . 140n can be stacked such that the respective locating feature protrusions 129′, 129″, . . . 129n arranged at respective corner portions 131′, 131″, . . . 131n of the respective cable skid systems 140′, 140″, . . . 140n engage with respective locating feature receptacles 133′, 133″, . . . 133n arranged at respective corner portions 131′, 131′, . . . 131n of each respective cable skid system 140′, 140″, . . . 140n. This stacked configuration facilitates storage and retrieval of the cable skid systems 140′, 140″, . . . 140n for faster commissioning and deployment.

As illustrated in FIG. 5B, each cable skid system 140′, 140″, . . . 140n includes locating feature protrusion 129′, 129″, . . . 129n, and a locating feature receptacle 131 , 131″, . . . 131n adjacent to the locating feature protrusion 129′, 129″, . . . 129n. Each locating feature protrusion 129′, 129″, . . . 129n of each cable skid system 140′, 140″, . . . 140n extends from a top portion of the cable skid system 140′, 140″, . . . 140n. Each locating feature receptacle 131′, 131″, . . . 131n extends from a bottom portion 140-1′, 140-1″, . . . 140-1n of the cable skid system 140′, 140″, . . . 140n.

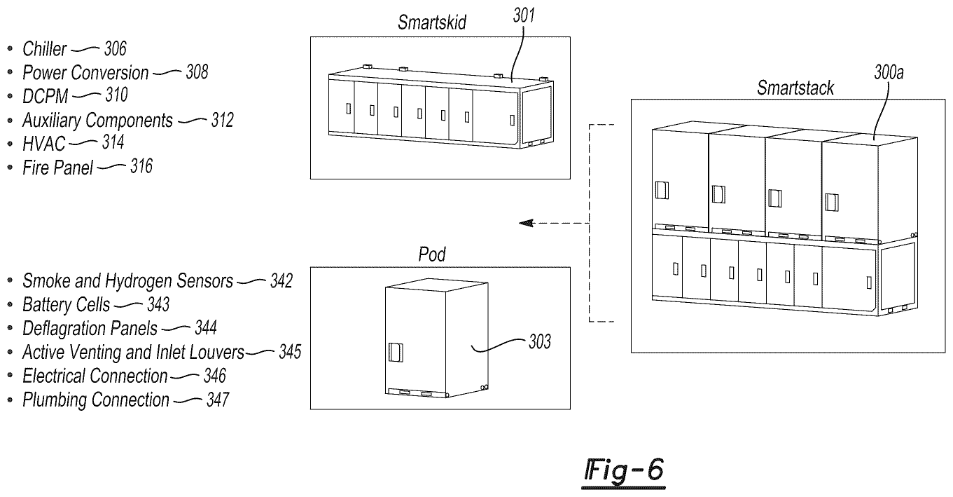

Turning next to FIG. 6, there is shown another example of a representative energy storage system 300a with which aspects of the present disclosure may be practiced. The energy storage system 300a includes a “smart skid” support structure 301 and multiple (e.g., four) battery pods 303 seated on and secured to the smart skid 301. The smart skid 301 of FIG. 6 contains a cooler 308, a power conversion system 308, a DC-DC power module (DCPM) 310, a set of auxiliary skid components 312, an HVAC system 314, and a fire panel 316. Each pod 303 may contain a network of smoke and hydrogen sensors 342, a set of interconnected and rechargeable battery cells 343, multiple deflagration panels 344, active venting and inlet louvers 345, a network of electrical connections 346, and a network of fluid plumbing connections 347.

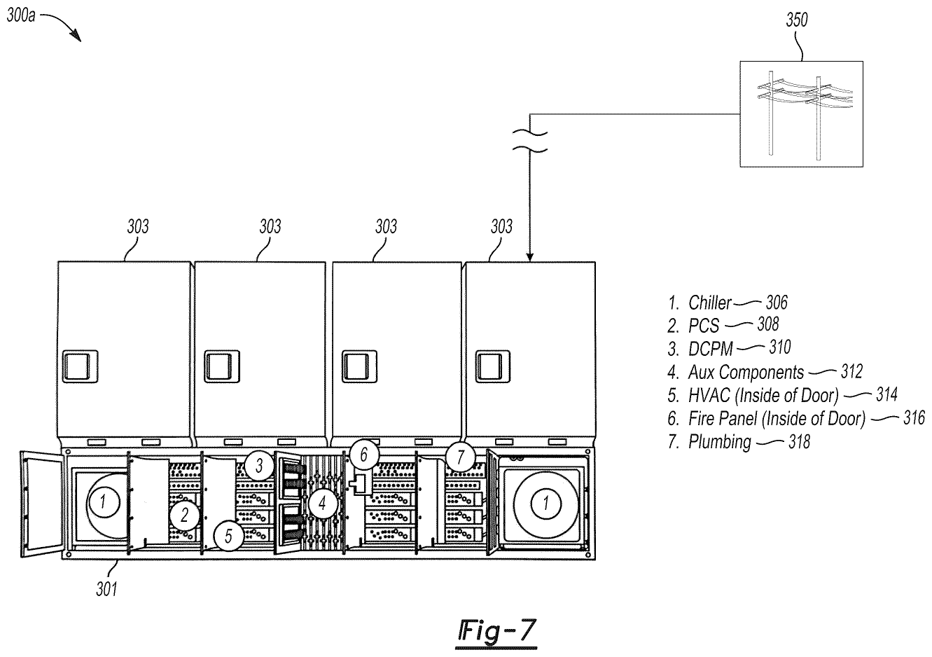

FIG. 7 provides a partially schematic, front-view illustration of the energy storage system 300a shown operatively connected to an external power source 350, such as a utility power grid, renewable energy system, etc. The smart skid 301 of FIG. 7 generally includes two coolers 308, the power conversion system 308, the DCPM 310, the auxiliary components 312, the HVAC system 314, the fire panel 316, and the plumbing 318. The energy storage system 300a may be coupled with the external power source 350. Although differing in appearance, it is envisioned that the energy storage system 300a of FIGS. 6 and 7 may include any of the features and options described above with reference to the battery system 100 of FIG. 1, and vice versa.

By providing a cable skid rapid deployment system for modular BESSs that facilitates installation of updated individual BESS units and/or new individual BESS units, installation site preparation time, effort, and cost is minimized.

These and other attendant benefits of the present disclosure will be appreciated by those skilled in the art in view of the foregoing disclosure.

The detailed description and the drawings or figures are supportive and descriptive of the present teachings, but the scope of the present teachings is defined solely by the claims. While some of the best modes and other examples for carrying out the present teachings have been described in detail, various alternative designs and aspects of the disclosure exist for practicing the present teachings defined in the appended claims.

What is claimed is:

1. A cable skid system for a modular battery energy storage system (BESS), the cable skid system comprising:
a BESS mounting frame configured for attachment to a BESS node;
a cable system cabling arranged within the BESS mounting frame; and
an electrical connection system configured for connection to the cable system cabling.

2. The cable skid system as recited in claim 1, wherein the BESS mounting frame includes at least one electrical connection system access.

3. The cable skid system as recited in claim 1, wherein the BESS mounting frame includes at least one cross beam.

4. The cable skid system as recited in claim 3, wherein the at least one cross beam includes an opening arranged within the cross beam.

5. The cable skid system as recited in claim 1, wherein the cable system cabling includes:
a first end configured for connection to a BESS node cabling; and
a second end configured for connection to the electrical connection system.

6. The cable skid system as recited in claim 1, wherein the electrical connection system includes:
a first portion having a first plurality of electrical connections located within the BESS mounting frame, wherein the first plurality of electrical connections is configured for connection to the BESS node cabling; and
a second portion having a second plurality of electrical connections, the second portion located within the BESS enclosure frame, wherein the second plurality of electrical connections is configured for connection to an external unit.

7. The cable skid system as recited in claim 1, further including:
a plurality of locating feature protrusions extending from a top surface of the cable skid system, wherein each of the plurality of locating feature protrusions is arranged at a corner portion of the cable skid system; and
a plurality of locating feature receptacles extending from a bottom surface of the cable skid system, wherein each of the locating feature receptacles is arranged at a respective corner portion of the cable skid system.

8. The cable skid system as recited in claim 7, wherein the cable skid system includes a first cable skid system, and second cable skid system, wherein the first cable skid system is arranged in a stacked configuration with the second cable skid system such that a plurality of locating feature protrusions extending from a top surface of the first cable skid system are receivable within a plurality of locating feature receptacles extending from a bottom surface of the second cable skid system.

9. A modular battery energy storage system (BESS) comprising:
a cable skid system including cable system cabling; and
a BESS node configured for attachment to the cable skid system, the BESS node including BESS node cabling, wherein the BESS node cabling of the BESS node is configured for connection to the cable system cabling of the cable skid system.

10. The modular BESS as recited in claim 9, wherein the cable skid system includes:
a BESS mounting frame, wherein the cable system cabling is arranged within the BESS mounting frame; and
an electrical connection system configured for connecting the BESS node cabling with the cable system cabling.

11. The modular BESS as recited in claim 10, wherein the BESS mounting frame includes at least one electrical connection system access.

12. The modular BESS as recited in claim 10, wherein the BESS mounting frame includes at least one cross beam.

13. The modular BESS as recited in claim 10, wherein the cable system cabling includes:
a first end configured for connection to the BESS node cabling; and
a second end configured for connection to the electrical connection system.

14. The modular BESS as recited in claim 10, wherein the electrical connection system includes:
a first portion having a first plurality of electrical connections located within the BESS mounting frame, wherein the first plurality of electrical connections is configured for connection to the BESS node cabling; and
a second portion having a second plurality of electrical connections, the second portion located within the BESS mounting frame, wherein the second plurality of electrical connections is configured for connection to an external unit.

15. The modular BESS as recited in claim 9, wherein the cable skid system further includes:
a plurality of locating feature protrusions extending from a top surface of the cable skid system, wherein each of the plurality of locating feature protrusions is arranged at a corner portion of the cable skid system; and
a plurality of locating feature receptacles extending from a bottom surface of the cable skid system, wherein each of the locating feature receptacles is arranged at a respective corner portion of the cable skid system.

16. The modular BESS as recited in claim 15, wherein the cable skid system includes a first cable skid system, and second cable skid system, wherein the first cable skid system is arranged in a stacked configuration with the second cable skid system such that a plurality of locating feature protrusions extending from a top surface of the first cable skid system are receivable within a plurality of locating feature receptacles extending from a bottom surface of the second cable skid system.

17. The modular BESS as recited in claim 10, wherein the cable system cabling includes:
a first end configured to be connected to the BESS node cabling; and
a second end configured to be connected to the electrical connection system.

18. The modular BESS as recited in claim 10, wherein the electrical connection system includes:
a first portion having a first plurality of electrical connections located within the BESS mounting frame, wherein the first plurality of electrical connections is configured for connection to the BESS node cabling; and
a second portion having a second plurality of electrical connections, the second portion located within the BESS mounting frame, wherein the second plurality of electrical connections is configured for connection to an external unit.

19. The modular BESS as recited in claim 9, wherein the BESS node includes:
at least one BESS enclosure, wherein the at least one BESS enclosure includes at least one battery rack including a plurality of battery nodes arranged within the at least one BESS enclosure.

20. A modular battery energy storage system (BESS) comprising:
a cable skid system including:
a cable skid system cabling;
a BESS mounting frame, wherein the cable skid system cabling is arranged within the BESS mounting frame; and
an electrical connection system configured for connecting the BESS node cabling with the cable skid system cabling; and
a BESS node configured for attachment to the cable skid system, the BESS node including BESS node cabling, wherein the BESS node cabling of the BESS node is configured for connection to the cable skid system cabling of the cable skid system.
